(19) United States
(12) Patent Application Publication
(10) Pub. No.: US 2007/0084938 A1
(43) Pub. Date: Apr. 19, 2007

(54) Variable single zone air volume control system and method

(76) Inventor: Mingsheng Liu, Omaha, NE (US)

Correspondence Address: MICHAEL BEST & FRIEDRICH, LLP, 100 E WISCONSIN AVENUE, Suite 3300, MILWAUKEE, WI, 53202, US

(21) Appl. No.: 11/584,000

(22) Filed: Oct. 18, 2006

Related U.S. Application Data
(60) Provisional application No. 60/727,811, filed on Oct. 18, 2005.

(51) Int. Cl. B64D 13/00

(52) U.S. Cl. 236/91 D

(57) ABSTRACT

A method of controlling airflow in a room using an airflow system including a fan, a compressor subsystem, a heating device, an outdoor temperature sensor, and a room temperature sensor associated with the room. The method includes determining an outdoor temperature using the outdoor temperature sensor and a room temperature using the room temperature sensor. The method also includes selectively activating the heating device or the compressor subsystem, determining a fan speed when one of the heating device and the compressor subsystem has been activated, and modulating the fan at the determined fan speed.

### RELATED APPLICATION

This application claims priority to U.S. Provisional Patent Application Ser. No. 60/727,811, filed on Oct. 18, 2005, the entire contents of which are incorporated herein by reference.

### FIELD

Embodiments of the invention relate generally to control systems and methods, and particularly to systems and methods to improve efficiency of airflow systems.

### BACKGROUND

Various types of facilities, such as buildings, industrial production facilities, medical buildings, manufacturing assemblies, and laboratories, often use airflow systems to condition various spaces of the facilities. Such airflow systems generally use fans to provide both heating and cooling.

Airflow systems often run fans at constant speeds, which can cause various problems. For example, fans continue to consume power even when fans are unnecessary. Further, when fans are installed inside facilities, they tend to generate perceptible noises. In some instances, airflow rates generated by fans are higher than required, which in turn can create humidity problems in facilities.

### SUMMARY

In one embodiment, the invention provides a method of controlling airflow in a room using an airflow system. The airflow system includes a fan, a compressor subsystem, a heating device, an outdoor temperature sensor, and a room temperature sensor associated with the room. The method includes determining an outdoor temperature using the outdoor temperature sensor, and determining a room temperature using the room temperature sensor. The method also includes selectively activating the heating device when the outdoor temperature and the room temperature satisfy a heating condition, and selectively activating the compressor subsystem when the outdoor temperature and the room temperature satisfy a cooling condition. When one of the heating device and the compressor subsystem has been activated, the method includes determining a fan speed and modulating the fan at the determined fan speed.

In another embodiment, the invention provides a controller for an airflow system. The airflow system includes a fan, a compressor subsystem, a heating device, an outdoor temperature sensor to determine an outdoor temperature, and a room temperature sensor to determine a room temperature. The controller includes a comparator, an activation module, an airflow rate module, and a modulator. The comparator compares the outdoor temperature with an outdoor temperature set point, and compares the room temperature with a room temperature set point. The activation module selectively activates one of the compressor subsystem and the heating device based on the comparing by the comparator. The airflow rate module determines an airflow rate when one of the heating device and the compressor subsystem has been activated. The modulator modulates a speed of the fan based on the determined airflow rate.

In another embodiment, the invention provides a method of controlling airflow in a room using an airflow system including a fan, a compressor subsystem, a heating device, an outdoor temperature sensor, and a room temperature sensor associated with the room. The method includes determining an outdoor temperature using the outdoor temperature sensor, and a room temperature using the room temperature sensor. The method also includes selecting one of a heating mode and a cooling mode based on the outdoor temperature and the room temperature, and selectively activating one of the heating device and the compressor subsystem based on one of the corresponding selected heating and cooling modes. The method also includes determining a fan speed when one of the heating device and the compressor subsystem has been activated, and modulating the fan at the determined fan speed.

Embodiments of the invention can be retrofitted to existing single zone roof top airflow units or incorporated in new systems. Some embodiments herein can reduce fan energy consumption by about 70 percent, provide humidity control under different load conditions, improve compressor efficiency, improve building acoustic performance, and increase compressor life span by about 50 percent.

Other aspects of the invention will become apparent by consideration of the detailed description and accompanying drawings.

### BRIEF DESCRIPTION OF THE DRAWINGS

FIG. 1 is a schematic diagram of an airflow system according to an embodiment of the invention.

FIG. 2 is a block diagram of a controller according to an embodiment of the invention.

FIG. 3 is a flow chart illustrating an exemplary heating and cooling selection process carried out in the controller of FIG. 2.

FIG. 4 is a flow chart illustrating an exemplary economizer control process carried out in the controller of FIG. 2.

FIG. 5 is a flow chart illustrating an exemplary fan speed control process carried out in the controller of FIG. 2.

FIG. 6 is a flow chart illustrating an exemplary single compressor control process carried out in the controller of FIG. 2.

FIG. 7 is a flow chart illustrating an exemplary multiple compressor control process carried out in the controller of FIG. 2.

FIG. 8 is a flow chart illustrating an exemplary heating device control process carried out in the controller of FIG. 2.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

As should also be apparent to one of ordinary skill in the art, the systems shown in the figures are models of what actual systems might be like. Many of the modules and logical structures described are capable of being implemented in software executed by a microprocessor or a similar device or of being implemented in hardware using a variety of components including, for example, application-specific integrated circuits (“ASICs”). Terms like “controller” may include or refer to both hardware and/or software. Furthermore, throughout the specification capitalized terms are used. Such terms are used to conform to common practices and to help correlate the description with the coding examples, equations, and/or drawings. However, no specific meaning is implied or should be inferred simply due to the use of capitalization. Thus, the claims should not be limited to the specific examples or terminology or to any specific hardware or software implementation or combination of software or hardware.

Also, as used herein, the term “refrigerant” refers to a fluid used for heating, cooling, and/or defrosting purposes, such as, for example, chlorofluorocarbons (“CFCs”), hydrocarbons, cryogens (e.g., CO₂ and N₂), etc.

Embodiments of the invention provide control systems and methods that can be retrofitted in existing airflow systems, or can be incorporated in new systems.

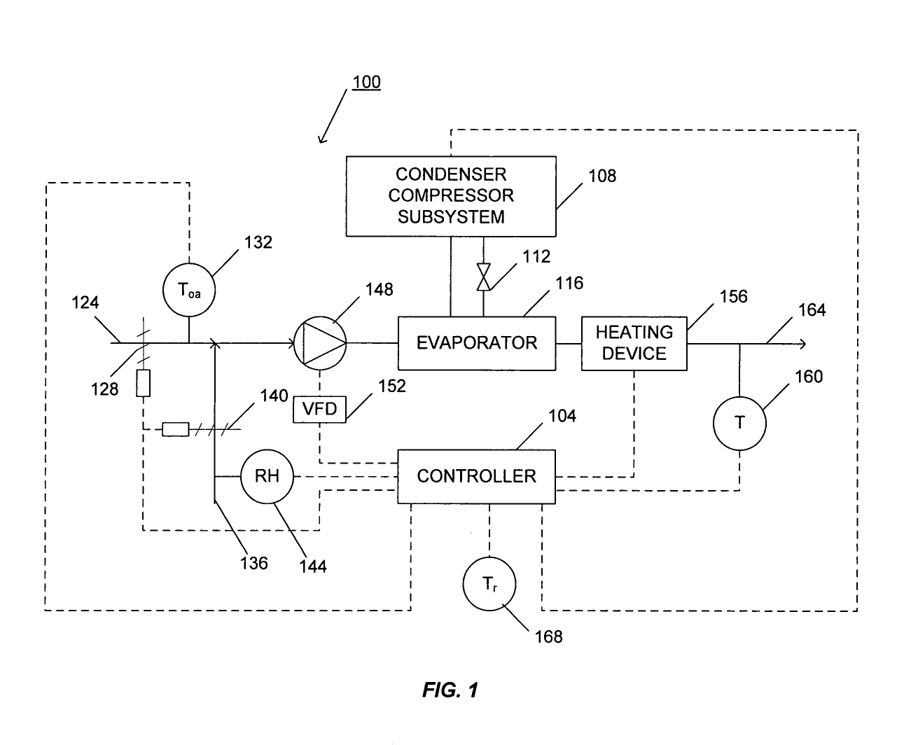

FIG. 1 is a schematic diagram of an air handling unit (“AHU”) or an airflow system 100 for providing airflow within a building or other structure (not shown). In the embodiment shown, the AHU 100 is a rooftop unit, although other AHU configurations can be used. The AHU 100 includes a direct expansion (“DX”) controller or a control unit 104 that controls a condenser-compressor unit or a compressor subsystem 108, an expansion valve 112, and an evaporator or DX coil 116. The compressor subsystem 108 can generally be driven by an internal combustion engine and a standby electric motor. In some embodiments, the compressor subsystem 108 has one or more stages of compressors. The term “compressor” used herein includes multi-stage compressors, single-stage compressors, and other types of compressors.

When the AHU 100 is operated in a cooling process, the expansion valve 112 is adjusted to direct refrigerant from the compressor subsystem 108 to the DX coil 116. An outside air duct 124 brings in outside air through an outside air damper or valve 128. An outside air temperature sensor 132 measures or senses a temperature of the outdoor air near the valve 128.

The AHU 100 also includes a return-air inlet 136 that collects air returned from the building to the AHU 100 through a return-air valve 140, and mixes the returned air with the outside air, thereby producing mixed air that has a mixed air temperature. A relative humidity (“RH”) sensor 144 positioned near the return-air valve 140 measures a RH of the returned air. The mixed air is subsequently drawn by a fan 148 into the DX coil 116. When the mixed air passes through the DX coil 116 in a cooling mode, the refrigerant within the DX coil 116 cools the mixed air to a predetermined temperature set point (or set points) by absorbing or removing the heat or energy in the mixed air. The expansion valve 112 generally regulates the amount of refrigerant passing through the DX coil 116, thereby controlling an amount of cooling applied to the mixed air. The refrigerant is then compressed and condensed by the compressor subsystem 108.

A variable frequency drive (“VFD”) 152 is coupled to the fan 148 in order to run the fan 148 at different speeds. As such, the fan 148 continues to convey the mixed or cooled air from the DX coil 116 to a heating device 156 at a variable fan airflow rate. When the AHU 100 is in a heating mode, the heating device 156 heats the mixed air to produce warm air. A supply air temperature sensor 160 positioned downstream from the heating device 156 measures a temperature of the cooled or warm air being supplied to the zone in the building associated with an outlet 164. A room temperature sensor 168 measures or senses a temperature of the zone or room in the building. After distribution to the various zones, the air in the zones is collected and returned through the return-air inlet 136. The airflow process is repeated. In some embodiments, the heating device 156 includes a heat pump, a gas furnace, or an electric duct heater.

The DX controller 104 receives a plurality of air-related conditions from various sensors, such as the outside air temperature from the outside air temperature sensor 132, the relative humidity level from the relative humidity sensor 144, the fan head pressure from a differential pressure sensor positioned near the fan 148, the supply air temperature from the supply air temperature sensor 160, and the room temperature from the room temperature sensor 168. Based on analytical or other processes such as described below, the DX controller 104 generates a plurality of control signals for use in the AHU 100. For example, the DX controller 104 can generate a fan speed control signal to drive the VFD 152. Further, the DX controller 104 can generate a plurality of valve control signals to open or close the valves 112, 128, and 140.

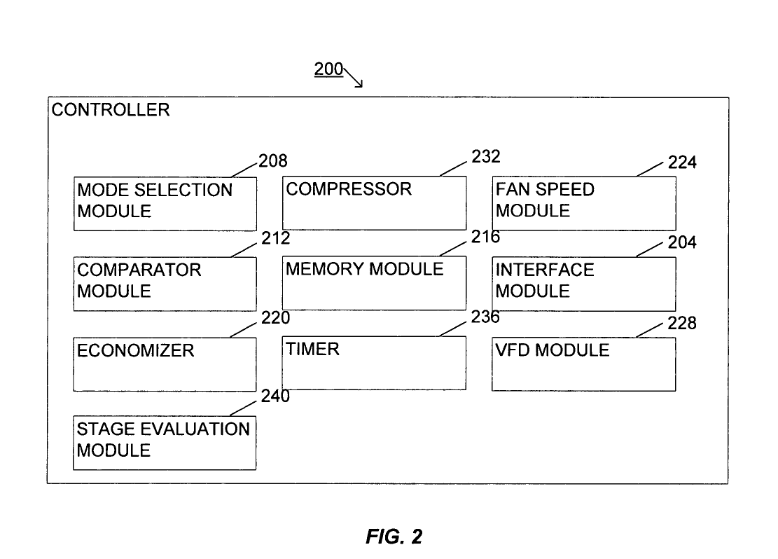

FIG. 2 is a block diagram of the DX controller 104 of FIG. 1. The DX controller 104 includes an interface module 204 that is configured to receive a plurality of air-related conditions and system operating conditions from sensors of the AHU 100 of FIG. 1, such as the outside air temperature sensor 132, the relative humidity sensor 144, and the fan speed sensor (not shown). Based on one or more of the sensed conditions, a mode selection module 208 determines which of the compressor subsystem 108 and the heating device 156 of FIG. 1 to be activated. A comparator 212 compares the sensed conditions, such as the outside air temperature, with a plurality of predetermined conditions, such as an outside air temperature set point, that are generally stored in a memory module 216. The comparator 212 sends a comparison signal, derived from the comparison between the sensed conditions and the predetermined conditions, to the mode selection module 208. Based on the comparison signal, the mode selection module 208 selects to enable or activate one of the compressor subsystem 108 and the heating device 156 of FIG. 1, while disabling the other, as further discussed below.

The DX controller 104 also includes an economizer module 220 to control an amount of outside air entering the building through the damper or the valve 128. As discussed, the amount of outside air entering through the valve 128 is mixed with a portion of the air returning from the building through the valve 140. A fan speed module 224 then determines a speed at which the fan is run, and a VFD module 228 sends a control signal to control the VFD 152 of FIG. 1 to modulate the fan based on the determined speed.

The DX controller 104 also includes a compressor control module 232 to regulate the compressor subsystem 108 of FIG. 1. The compressor control module 232 uses a timer 236 to determine how long the compressor subsystem 108 has been deactivated. If the compressor subsystem 108 has been deactivated for a predetermined amount of time, the compressor control module 232 may re-activate the compressor subsystem 108. The compressor control module 232 also has an optional stage-evaluation module 240 to determine a number of compressor stages incorporated in the compressor subsystem 108. Depending on the number of compressor stages determined, the DX controller 104 and the compressor control module 232 adjust a plurality of control signals being sent to the compressor subsystem 108, as discussed in further detail below.

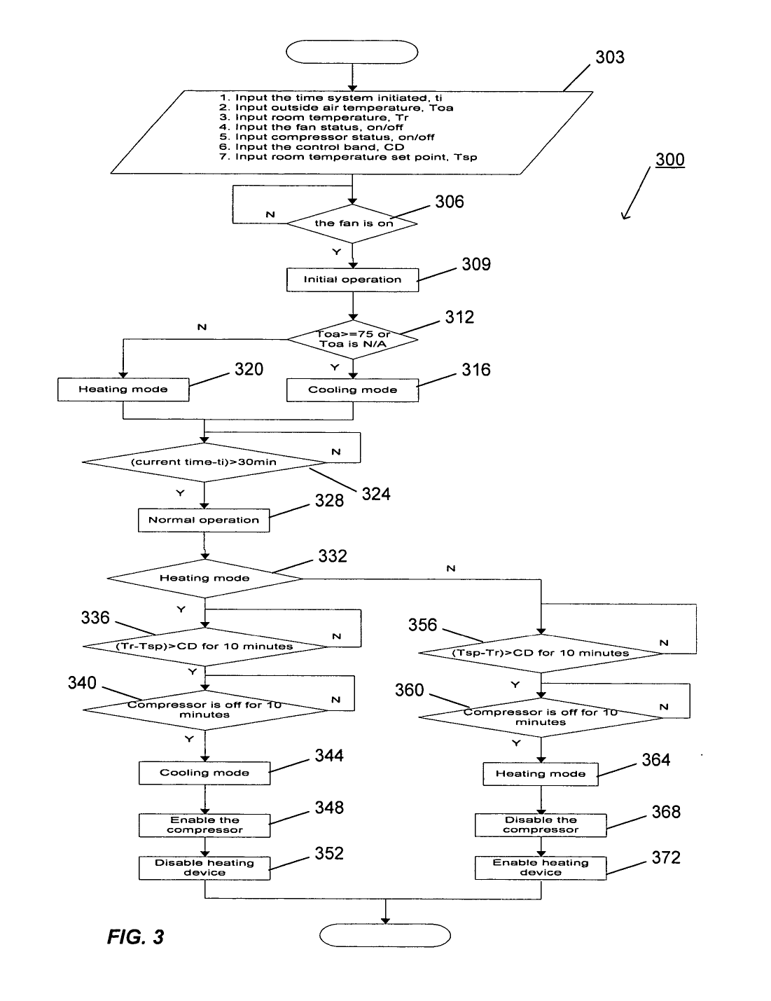

FIG. 3 is a flow chart illustrating an exemplary mode selection process 300 carried out in the controller 104 of FIG. 2. At block 303, the mode selection process 300 initializes a plurality of parameters. In some embodiments, the parameters include a time when the AHU 100 was initiated (“tᵢ”), an outdoor temperature (“Tₒₐ”) sensed by the sensor 132, a room temperature (“Tᵣ”) sensed by the sensor 168, an ON/OFF operating status of the fan 148, an ON/OFF operating status of the compressor subsystem 108, a control band (“CD”) of the AHU 100, and a room temperature set point (“Tᵣₛₚ”).

At block 306, the mode selection process 300 determines if the fan 148 has been activated or turned on. If the mode selection process 300 determines that the fan 148 is not activated, the mode selection process 300 repeats block 306 until the fan 148 has been activated. Otherwise, if the mode selection process 300 determines that the fan 148 has been activated, the mode selection process 300 proceeds to initialize components of the AHU 100 of FIG. 1 at block 309.

At block 312, the mode selection process 300 determines if Tₒₐ is available, and if Tₒₐ is available, the mode selection process 300 compares Tₒₐ with an outdoor temperature threshold Tₒₐₛₚ, such as 75° F. If the mode selection process 300 determines that Tₒₐ is unavailable, or when Tₒₐ is greater than or equal to an outdoor temperature threshold Tₒₐₛₚ, the mode selection process 300 proceeds to enter a cooling mode at block 316. Otherwise, when Tₒₐ is less than the outdoor temperature threshold Tₒₐₛₚ, the mode selection process 300 proceeds to enter a heating mode at block 320.

At block 324, the mode selection process 300 compares a current time (“t_{c}”) with tᵢ to determine if the mode selection process 300 or the AHU 100 has been operating for a predetermined amount of operating time (“tₒₚₑᵣₐₜₑ”), such as 30 minutes. If the mode selection process 300 or the AHU 100 has not been operating for more than tₒₚₑᵣₐₜₑ, the mode selection process 300 will wait until the mode selection process 300 or the AHU 100 has been operating for at least tₒₚₑᵣₐₜₑ at block 324. After the mode selection process 300 or the AHU 100 has been operating for at least tₒₚₑᵣₐₜₑ, the mode selection process 300 proceeds to a normal operation mode at block 328.

At block 332, the mode selection process 300 determines if the heating mode has been selected earlier at block 312. If the mode selection process 300 determines that the heating mode has been selected, the mode selection process 300 proceeds to determine a difference between Tᵣ and Tᵣₛₚ, compare the difference with CD, and determine if the difference is greater than CD for a predetermined amount of time (“t_{difference sp}”), such as 10 minutes, at block 336. In this way, the mode selection process 300 can determine whether the sensed room temperature has exceeded the room temperature set point by at least an amount greater than the predetermined control band for at least some amount of time. If the mode selection process 300 determines that the difference is greater than CD for less than t_{difference sp}, Tᵣ is less than Tᵣₛₚ, or the difference is less than CD (i.e., a negative determination is made in block 336), the mode selection process 300 repeats block 336.

However, if the mode selection process 300 determines that Tᵣ is greater than Tᵣₛₚ, the difference is greater than CD, and the difference is greater than CD for more than t_{difference sp} (i.e., a positive determination is made in block 336), the mode selection process 300 proceeds to block 340. At block 340, the mode selection process 300 determines if the compressor subsystem 108 has been turned off or deactivated for a predetermined amount of time (“t_{compressor off}”). If the mode selection process 300 determines that the compressor subsystem 108 has not been turned off or deactivated for t_{compressor off}, the mode selection process 300 repeats block 340. Otherwise, if the mode selection process 300 determines that the compressor subsystem 108 has been turned off or deactivated for t_{compressor off} amount of time, the mode selection process 300 generates an activation signal for the compressor subsystem 108 to enter the cooling mode, and a deactivation signal for the heating device 156 at block 344. Thereafter, the mode selection process 300 activates the compressor subsystem 108 with the activation signal for the compressor subsystem 108 at block 348, deactivates the heating device 156 with the deactivation signal for the heating device 156 at block 352, and terminates thereafter.

Referring back to block 332, if the mode selection process 300 determines that the heating mode has not been selected, the mode selection process 300 defaults to a cooling mode. Subsequently, the mode selection process 300 proceeds to determine a difference between Tᵣₛₚ and Tᵣ, compares the difference with CD, and determines if the difference has been greater than CD for t_{difference sp} at block 356. In this way, the mode selection process 300 can determine whether the sensed room temperature is less than the room temperature set point by at least an amount greater than the predetermined control band for at least some amount of time. If the mode selection process 300 determines that the difference is greater than CD for less than t_{difference sp} amount of time, Tᵣₛₚ is less than Tᵣ, or the difference is less than CD (i.e., a negative determination is made in block 356), the mode selection process 300 repeats block 356.

However, if the mode selection process 300 determines that Tᵣₛₚ is greater than Tᵣ, the difference is greater than CD, and the difference has been greater than CD for at least t_{difference sp} (i.e., a positive determination is made in block 356), the mode selection process 300 proceeds to block 360 to determine if the compressor subsystem 108 has been turned off or deactivated for t_{compressor off}. If the mode selection process 300 determines that the compressor subsystem 108 has not been turned off or deactivated for t_{compressor off}, the mode selection process 300 repeats block 360. Otherwise, if the mode selection process 300 determines that the compressor subsystem 108 has been turned off or deactivated for t_{compressor off}, the mode selection process 300 generates an activation signal for the heating device 156 to enter the heating mode, and a deactivation signal for the compressor subsystem 108 at block 364. Thereafter, the mode selection process 300 disables or deactivates the compressor subsystem 108 with the deactivation signal for the compressor subsystem 108 at block 368, enables or activates the heating device 156 with the activation signal for the heating device 156 at block 372, and terminates thereafter.

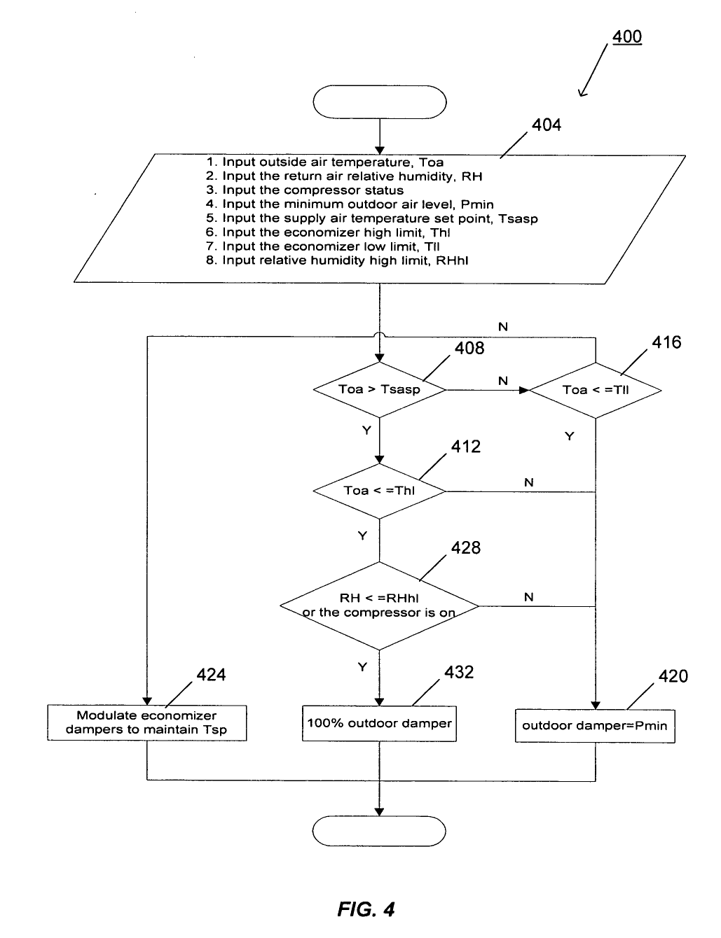

FIG. 4 is a flow chart illustrating an exemplary economizer control process 400 carried out in the controller 104 of FIG. 2. At block 404, the economizer control process 400 initializes a plurality of parameters. In some embodiments, the parameters include the outdoor temperature (“Tₒₐ”) sensed by the sensor 132, the return air relative humidity (“RH”), the ON/OFF operating status of the compressor subsystem 108, a minimum outdoor air level (“Pₘᵢₙ”), a supply air temperature set point (“Tₛₐₛₚ”), an economizer high limit (“T_{high limit}”), an economizer low limit (“T_{low limit}”), and a relative humidity high limit (“RH_{high limit}”)

At block 408, the economizer control process 400 compares Tₒₐ with Tₛₐₛₚ. If the economizer control process 400 determines that Tₒₐ is greater than Tₛₐₛₚ, the economizer control process 400 proceeds to block 412 to compare Tₒₐ with T_{high limit}. Otherwise, if the economizer control process 400 determines that Tₒₐ is less than or equal to Tₛₐₛₚ, the economizer control process 400 proceeds to block 416 to compare Tₒₐ with T_{low limit}. At block 416, if the economizer control process 400 determines that Tₒₐ is less than or equal to T_{low limit}, the economizer control process 400 proceeds to block 420 to set the valve 128 at the minimum outdoor air level (“Pₘᵢₙ”), and terminates thereafter. Otherwise, if the economizer control process 400 determines that Tₒₐ is greater than T_{low limit} in block 416, the economizer control process 400 proceeds to block 424 to modulate the valve 128 to maintain the room temperature at the room temperature set point (“Tᵣₛₚ”), and terminates thereafter.

Referring to block 412, the economizer control process 400 compares Tₒₐ with T_{high limit}. If the economizer control process 400 determines that Tₒₐ is greater than T_{high limit}, the economizer control process 400 proceeds to block 420. Otherwise, if the economizer control process 400 determines that Tₒₐ is less than or equal to T_{high limit}, the economizer control process 400 proceeds to block 428 to compare RH with RH_{high limit} or determine if the compressor subsystem 108 has been activated or deactivated.

If the economizer control process 400 determines that RH is greater than RH_{high limit}, and that the compressor subsystem 108 has been deactivated, the economizer control process 400 proceeds to block 420. Otherwise, if the economizer control process 400 determines that RH is less than or equal to RH_{high limit}, or that the compressor subsystem 108 has been activated, the economizer control process 400 fully opens the valve 128 at block 432, and terminates thereafter.

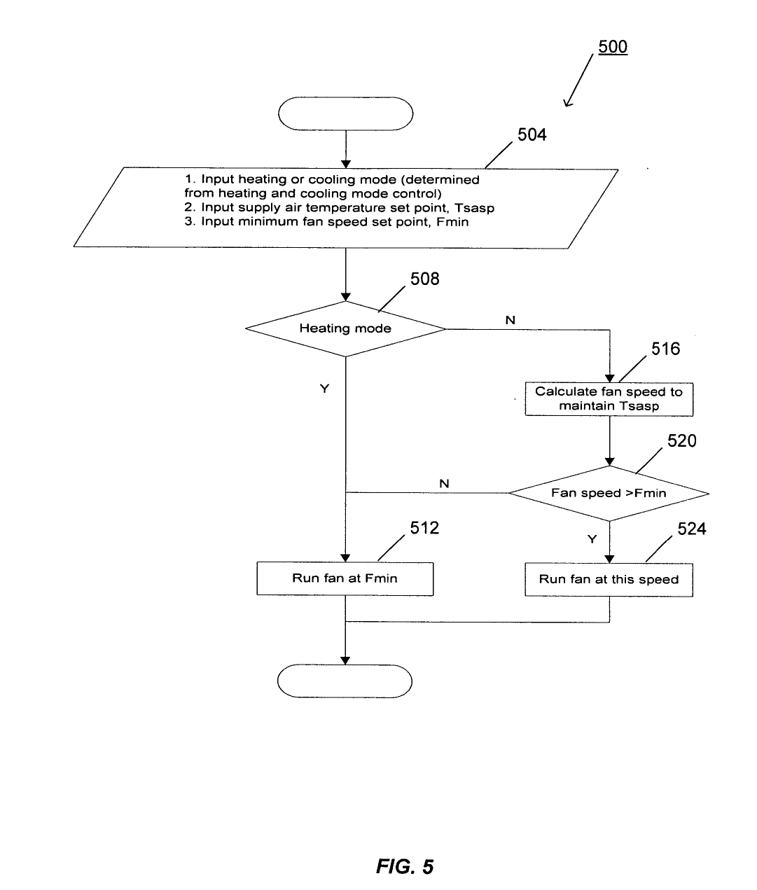

FIG. 5 is a flow chart illustrating an exemplary fan speed control process 500 carried out in the controller 104 of FIG. 2. At block 504, the fan speed control process 500 initializes a plurality of parameters. In some embodiments, the parameters include (1) one or more parameters indicating that the AHU 100 is in the heating mode or in the cooling mode as determined in the mode selection process 300 of FIG. 3, (2) the supply air temperature set point (“Tₛₐₛₚ”), and (3) a minimum fan speed set point (“Fₘᵢₙ”).

At block 508, the fan speed control process 500 determines if the heating mode has been selected in the mode selection process 300 of FIG. 1. If the fan speed control process 500 determines that the heating mode has been selected, as determined by block 508, the fan speed control process 500 sets a fan speed at the minimum fan speed set point (“Fₘᵢₙ”) at block 512. The VFD 152 of FIG. 1 then modulates the fan speed accordingly.

If the fan speed control process 500 determines that the cooling mode has been selected, as determined by block 508, the fan speed control process 500 proceeds to determine a fan speed such that the AHU 100 can maintain the supply air temperature (“Tₛₐ”) at the supply air temperature set point (“Tₛₐₛₚ”) at block 516. The fan speed control process 500 then determines if the fan speed determined at block 516 is greater than the minimum fan speed set point (“Fₘᵢₙ”) at block 520. If the fan speed control process 500 determines that the fan speed determined at block 516 is less than or equal to the minimum fan speed set point at block 520, the fan speed control process 500 proceeds to block 512. However, if the fan speed control process 500 determines that the fan speed determined at block 516 is greater than the minimum fan speed set point at block 520, the fan speed control process 500 proceeds to block 524 to set the fan speed at the fan speed determined at block 516. The VFD 152 of FIG. 1 then modulates the fan speed accordingly.

In general, the fan speed control process 500 determines an airflow rate (“Q”) of the fan 148 of FIG. 1 as follows. A specific equation for determining the airflow rate is used depending on a type of fan curve associated with the fan 148. Typically, there are a number of types of fan curves, such as a steep fan curve and a flat fan curve. Fans with a steep fan curve include fans whose differential pressure or fan head increases as a result of decreasing airflow rates (“Q”) at the same fan speed (“N”). Fans with a flat fan curve include fans whose differential pressure or fan head remains generally constant when the fan airflow rate (“Q”) changes. For such fans, the fan power varies significantly when the fan airflow rate changes at the same fan speed.

In some embodiments, the fan speed control process 500 can use EQN. (1) to determine the fan airflow rate (“Q”) of the fan 148, which is measured in cubic-feet-per-minute (“CFM”), for fans with a steep fan curve. EQN. (1) is based on a measured fan head (“H”), and a ratio (“ω”) between the fan speed (“N”) that is measured in revolutions-per-minute (“RPM”) and a design fan speed (“N_{d}”) that is also measured in RPM.

$$Q = ( \frac{- {a}_{1} - \sqrt{{a}_{1}^{2} - 4 {a}_{2} ( {a}_{0} - \frac{H}{{ω}^{2}} )}}{2 {a}_{2}} ) ω \qquad ( 1 )$$

In EQN. (1), a₀, a₁, and a₂ are fan curve coefficients obtained from the fan curve, typically provided by manufacturers of the fan 148.

Further, the fan speed control process 500 can also use EQN. (2) to determine the fan airflow rate (“Q”) for fans with a flat fan curve. EQN. (2) is based on the ratio (“ω”), and a fan power (“w_{f}”).

$$Q = \frac{- {b}_{1} {ω}^{2} - \sqrt{{b}_{1}^{2} {ω}^{4} - 4 {b}_{2} ω ( {b}_{0} {ω}^{3} - {w}_{f} )}}{2 {b}_{2} ω} \qquad ( 2 )$$

In EQN. (2), b₀, b₁, and b₂ are fan power curve coefficients, also provided by manufacturers of the fan 148. In this way, the process 500 can determine the fan airflow rate (“Q”) using either of the above equations as appropriate.

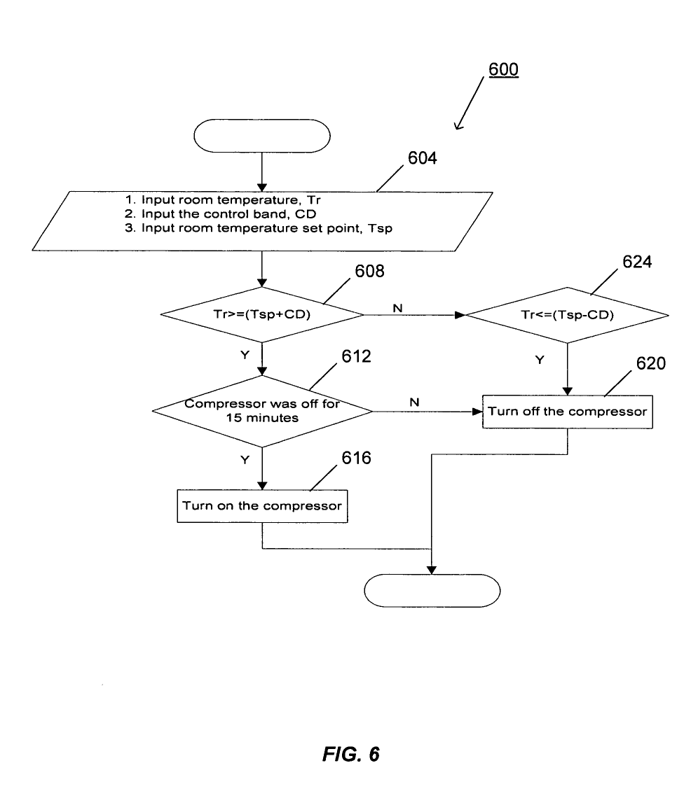

FIG. 6 is a flow chart illustrating a compressor control process 600, for a single-stage compressor incorporated in the compressor subsystem 108, carried out in the controller 104 of FIG. 2. At block 604, the compressor control process 600 initializes a plurality of parameters. In some embodiments, the parameters include the room temperature (“Tᵣ”) sensed by the sensor 168 of FIG. 1, the control band (“CD”) of the AHU 100, and the room temperature set point (“Tᵣₛₚ”).

At block 608, the compressor control process 600 compares the room temperature (“Tᵣ”) sensed by the sensor 168 of FIG. 1 with the room temperature set point (“Tᵣₛₚ”). Particularly, the compressor control process 600 compares the room temperature (“Tᵣ”) with a sum of the room temperature set point (“Tᵣₛₚ”) and the control band CD. If the compressor control process 600 determines that the room temperature (“Tᵣ”) is greater than or equal to the sum (i.e., the room temperature Tᵣ exceeds the room temperature set point Tᵣₛₚ by at least CD), the compressor control process 600 determines if the single-stage compressor has been turned off or disabled for a predetermined amount of time, such as 15 minutes, at block 612. If the compressor control process 600 determines that the single-stage compressor has been turned off or disabled for the predetermined amount of time, the compressor control process 600 generates an activation signal to activate or enable the single-stage compressor, and turns on the single-stage compressor at block 616. However, if the compressor control process 600 determines that the single-stage compressor has not been turned off or disabled for the predetermined amount of time, the compressor control process 600 generates a deactivation signal to deactivate or disable the single-stage compressor, and turns off or disables the single-stage compressor at block 620. The compressor control process 600 terminates thereafter.

Referring back to block 608, if the compressor control process 600 determines that the room temperature (“Tᵣ”) is less than the sum as described earlier, the compressor control process 600 proceeds to block 624. In such cases, the compressor control process 600 compares the room temperature with a difference between the room temperature set point (“Tᵣₛₚ”) and the control band CD. Particularly, if the compressor control process 600 determines that the room temperature is less than or equal to the difference between the room temperature set point (“Tᵣₛₚ”) and the control band CD, the compressor control process 600 proceeds to block 620. However, if the compressor control process 600 determines that the room temperature is greater than the difference between the room temperature set point (“Tᵣₛₚ”) and the control band CD, the compressor control process 600 repeats block 624.

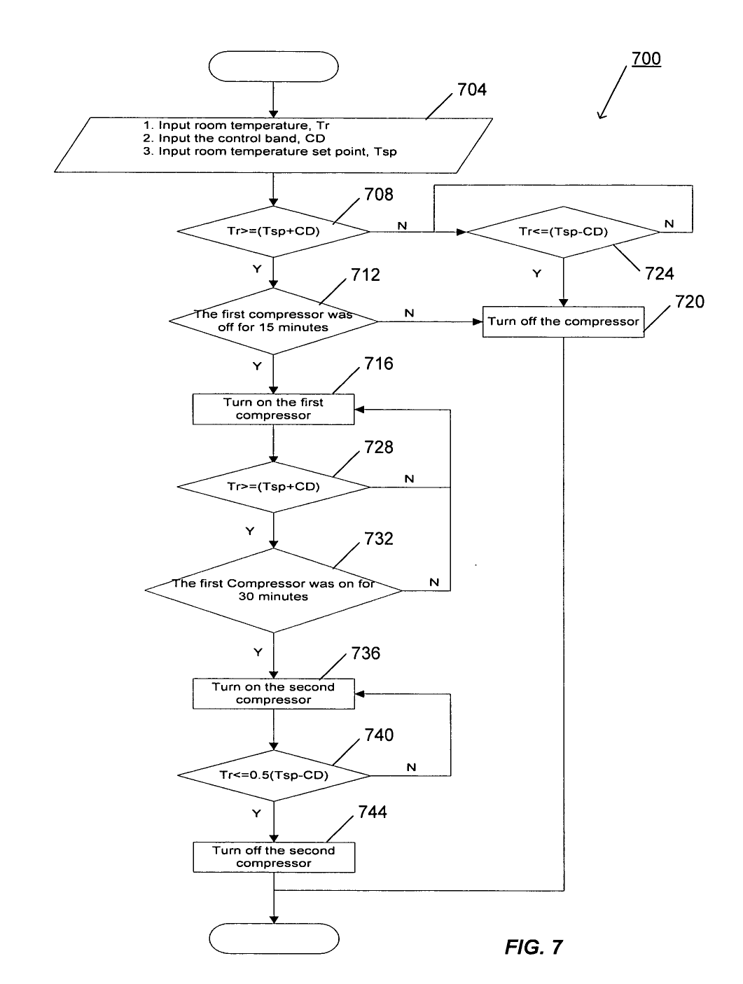

FIG. 7 is a flow chart illustrating a second compressor control process 700, for a compressor subsystem 108 having two compressors, carried out in the controller 104 of FIG. 2. Similar to the compressor control process 600 relating to a single compressor, the second compressor control process 700 also initializes parameters at block 704. In some embodiments, the parameters include the room temperature (“Tᵣ”) sensed by the sensor 168 of FIG. 1, the control band (“CD”) of the AHU 100, and the room temperature set point (“Tᵣₛₚ”). Although the second compressor control process 700 is shown to control a compressor subsystem 108 having two compressors, the second compressor control process 700 can be expanded to control additional compressors.

At block 708, similar to the compressor control process 600, the second compressor control process 700 compares the room temperature (“Tᵣ”) with the sum as described earlier. If the second compressor control process 700 determines that the room temperature (“Tᵣ”) is greater than or equal to the sum (i.e., the room temperature Tᵣ exceeds the room temperature set point Tᵣₛₚ by at least CD), the second compressor control process 700 determines if a first of the two compressors has been turned off or disabled for the predetermined amount of time at block 712. If the second compressor control process 700 determines that the first compressor has been turned off or disabled for the predetermined amount of time, the second compressor control process 700 generates an activation signal to activate or enable the first compressor, and turns on the first compressor at block 716. However, if the second compressor control process 700 determines that the first stage compressor has not been turned off or disabled for the predetermined amount of time, the second compressor control process 700 generates a deactivation signal to deactivate or disable the first compressor, and turns off or disables the first compressor at block 720. The second compressor control process 700 terminates thereafter.

Referring back to block 708, if the second compressor control process 700 determines that the room temperature (“Tᵣ”) is less than the sum as described earlier, the second compressor control process 700 proceeds to block 724. In such cases, the second compressor control process 700 compares the room temperature with the difference as described earlier. Particularly, if the second compressor control process 700 determines that the room temperature is less than or equal to the difference, the second compressor control process 700 proceeds to block 720. However, if the second compressor control process 700 determines that the room temperature is greater than the difference, the second compressor control process 700 repeats block 724.

After the first compressor has been activated at block 716, the second compressor control process 700 proceeds to repeat similar operations for a second of the two compressors. For example, the second compressor control process 700 compares the room temperature (“Tᵣ”) with the sum as described earlier at block 728. If the second compressor control process 700 determines that the room temperature (“Tᵣ”) is greater than or equal to the sum, the second compressor control process 700 determines if the first compressor has been enabled or activated for a predetermined amount of time, such as 30 minutes, at block 732. If the second compressor control process 700 determines that the first compressor has not been enabled or activated for the predetermined amount of time, or if the room temperature (“Tᵣ”) is less than the sum, the second compressor control process 700 repeats block 716. Otherwise, when the second compressor control process 700 determines that the first compressor has been enabled or activated for a predetermined amount of time at block 732, the second compressor control process 700 proceeds to generate an activation signal to activate or enable the second compressor, and turns on the second compressor at block 736.

Thereafter, the second compressor control process 700 proceeds to compare the room temperature with a portion of the difference as described above. For example, at block 740, the second compressor control process 700 compares the room temperature with about half of the difference. If the second compressor control process 700 determines at block 740 that the room temperature is greater than the portion of the difference, the second compressor control process 700 repeats block 736. Otherwise, if the second compressor control process 700 determines at block 740 that the room temperature is less than or equal to the portion of the difference, the second compressor control process 700 proceeds to generate a deactivation signal to turn off, disable, or deactivate the second compressor at block 744, and terminates thereafter.

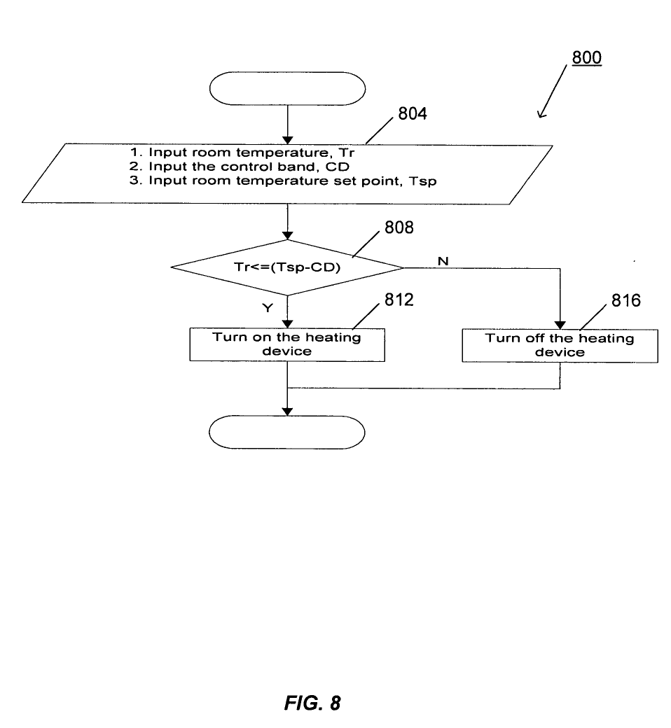

FIG. 8 is a flow chart illustrating an exemplary heating device control process 800 carried out in the controller 104 of FIG. 2. At block 804, the heating device control process 800 initializes a plurality of parameters. In some embodiments, the parameters include the room temperature (“Tᵣ”) sensed by the sensor 168 of FIG. 1, the control band (“CD”) of the AHU 100, and the room temperature set point (“Tᵣₛₚ”).

At block 808, the heating device control process 800 compares the room temperature with the difference as described earlier. Particularly, if the heating device control process 800 determines that the room temperature is less than or equal to the difference, the heating device control process 800 proceeds to generate an activation signal to turn on, enable, or activate the heating device 156 at block 812, and terminates thereafter. Otherwise, if the heating device control process 800 determines that the room temperature is greater than the difference, the heating device control process 800 proceeds to generate a deactivation signal to turn off, disable, or deactivate the heating device 156 at block 816, and terminates thereafter.

Various features and advantages of the invention are set forth in the following claims.

What is claimed is:

1. A method of controlling airflow in a room using an airflow system including a fan, a compressor subsystem, a heating device, an outdoor temperature sensor, and a room temperature sensor associated with the room, the method comprising:
determining an outdoor temperature using the outdoor temperature sensor;
determining a room temperature using the room temperature sensor;
selectively activating the heating device when the outdoor temperature and the room temperature satisfy a heating condition;
selectively activating the compressor subsystem when the outdoor temperature and the room temperature satisfy a cooling condition;
determining a fan speed when one of the heating device and the compressor subsystem has been activated; and
modulating the fan at the determined fan speed.

2. The method of claim 1, wherein determining the heating condition comprises:
determining a deactivated compressor time, a deactivated compressor time set point, a room temperature set point, and an outdoor temperature set point;
comparing the deactivated compressor time with the deactivated compressor time set point;
comparing the room temperature with the room temperature set point; and
comparing the outdoor temperature with the outdoor temperature set point.

3. The method of claim 2, further comprising:
disabling the heating device when the room temperature is greater than the room temperature set point by at least a predetermined amount; and
enabling the compressor subsystem when the room temperature is greater than the room temperature set point by at least the predetermined amount and the deactivated compressor time is at least equal to the deactivated compressor time set point.

4. The method of claim 1, wherein determining the cooling condition comprises:
determining a deactivated compressor time, a deactivated compressor time set point, a room temperature set point, and an outdoor temperature set point;
comparing the deactivated compressor time with the deactivated compressor time set point;
comparing the room temperature with the room temperature set point; and
comparing the outdoor temperature with the outdoor temperature set point.

5. The method of claim 4, further comprising:
disabling the compressor subsystem when the room temperature is less than the room temperature set point by a predetermined amount; and
enabling the heating device when the room temperature set point is greater than the room temperature by at least the predetermined amount and the deactivated compressor time is at least equal to the deactivated compressor time set point.

6. The method of claim 1, wherein determining a fan speed when the heating device has been activated comprises setting the fan speed at about a minimum fan speed.

7. The method of claim 1, wherein determining a fan speed when the compressor subsystem has been activated comprises:
determining a supply air temperature set point;
determining a fan speed value to maintain the supply air temperature set point;
comparing the fan speed value with a minimum fan speed; and
setting the fan speed at one of the minimum fan speed and the fan speed value based on the comparison.

8. The method of claim 1, further comprising determining a number of compressors incorporated in the compressor subsystem.

9. The method of claim 8, wherein the compressor subsystem comprises one compressor, the method further comprising:
comparing the room temperature with a room temperature set point;
determining an amount of time for which the compressor has been deactivated when the room temperature is greater than the room temperature set point by at least a predetermined amount;
comparing the amount of time with a compressor deactivation time;
activating the compressor when the amount of time is at least equal to the compressor deactivation time; and
deactivating the compressor when the room temperature is less than or equal to a difference between the room temperature set point and the predetermined amount.

10. The method of claim 8, wherein the compressor subsystem comprises at least two compressors, the method further comprising:
comparing the room temperature with a room temperature set point;
determining an amount of time for which one of the at least two compressors has been deactivated when the room temperature is greater than the room temperature set point by at least a predetermined amount;
comparing the amount of time with a compressor deactivation time;
activating the one of the at least two compressors when the amount of time is at least equal to the compressor deactivation time;
deactivating the one of the at least two compressors when the room temperature is less than or equal to a difference between the room temperature set point and the predetermined amount; and
activating another one of the least two compressors after the amount of time is at least approximately twice the compressor deactivation time.

11. A controller for an airflow system including a fan, a compressor subsystem, a heating device, an outdoor temperature sensor operable to determine an outdoor temperature, and a room temperature sensor operable to determine a room temperature, the controller comprising:
a comparator configured to compare the outdoor temperature with an outdoor temperature set point, and to compare the room temperature with a room temperature set point;
an activation module configured to selectively activate one of the compressor subsystem and the heating device based on the comparing by the comparator;
an airflow rate module configured to determine an airflow rate when one of the heating device and the compressor subsystem has been activated; and
a modulator configured to modulate a speed of the fan based on the determined airflow rate.

12. The controller of claim I 1, further comprising a timer configured to determine a deactivated compressor time, wherein the comparator is further configured to compare the deactivated compressor time with a deactivated compressor time set point.

13. The controller of claim 12, further comprising a mode selection module configured to disable the heating device when the room temperature is greater than the room temperature set point by at least a predetermined amount, and to enable the compressor subsystem when the room temperature is greater than the room temperature set point by the predetermined amount and the deactivated compressor time is at least equal to the deactivated compressor time set point.

14. The controller of claim 12, further comprising a mode selection module configured to disable the compressor subsystem when the room temperature is less than the room temperature set point by at least a predetermined amount, and to enable the heating device when the room temperature set point is greater than the room temperature by at least the predetermined amount and the deactivated compressor time is at least equal to the deactivated compressor time set point.

15. The controller of claim 11, further comprising a storage module configured to store a supply air temperature set point and a minimum fan speed, wherein the airflow rate module is further configured to determine a fan speed value to maintain the supply air temperature set point, the comparator is further configured to compare the fan speed value with the minimum fan speed, and the modulator is further configured to set the fan speed at one of the minimum fan speed and the fan speed value based on the comparison.

16. A method of controlling airflow in a room using an airflow system including a fan, a compressor subsystem, a heating device, an outdoor temperature sensor, and a room temperature sensor associated with the room, the method comprising:
determining an outdoor temperature using the outdoor temperature sensor;
determining a room temperature using the room temperature sensor;
selecting one of a heating mode and a cooling mode based on the outdoor temperature and the room temperature;
selectively activating one of the heating device and the compressor subsystem based on one of the corresponding selected heating and cooling modes;
determining a fan speed when one of the heating device and the compressor subsystem has been activated; and
modulating the fan at the determined fan speed.

17. The method of claim 16, wherein selecting one of a heating mode and a cooling mode comprises:
determining a deactivated compressor time, a deactivated compressor time set point, a room temperature set point, and an outdoor temperature set point;
comparing the deactivated compressor time with the deactivated compressor time set point;
comparing the room temperature with the room temperature set point; and
comparing the outdoor temperature with the outdoor temperature set point.

18. The method of claim 17, further comprising:
disabling the heating device when the room temperature is greater than the room temperature set point by at least a predetermined amount; and
enabling the compressor subsystem when the room temperature is greater than the room temperature set point by at least the predetermined amount and the deactivated compressor time is at least equal to the deactivated compressor time set point.

19. The method of claim 17, further comprising:
disabling the compressor subsystem when the room temperature is less than the room temperature set point by at least a predetermined amount; and
enabling the heating device when the room temperature set point is greater than the room temperature by at least the predetermined amount and the deactivated compressor time is at least equal to the deactivated compressor time set point.

20. The method of claim 16, wherein determining a fan speed when the heating device has been activated comprises setting the fan speed at about a minimum fan speed.
